(19) United States
(12) Patent Application Publication
(10) Pub. No.: US 2023/0229885 A1
(43) Pub. Date: Jul. 20, 2023

(54) IDENTIFICATION TAG READING METHOD AND METHOD FOR MANUFACTURING ARTICLE WITH IDENTIFICATION TAG

(71) Applicant: Murata Manufacturing Co., Ltd., Nagaokakyo-shi (JP)

(72) Inventor: Yoshiki NIKI, Nagaokakyo-shi (JP)

(21) Appl. No.: 18/188,743

(22) Filed: Mar. 23, 2023

Related U.S. Application Data
(63) Continuation of application No. PCT/JP2021/034395, filed on Sep. 17, 2021.

(30) Foreign Application Priority Data
Sep. 30, 2020 (JP) 2020-165584

(51) Int. Cl. G06K 19/08; G06K 19/06

(52) U.S. Cl. CPC G06K 19/086; G06K 19/06084

(57) ABSTRACT

A method for reading an identification tag is provided that includes detecting a content of particles having a first feature amount as a specific feature amount, where the particles are included in the identification tag; and distinguishing a type of the identification tag by information on the content of the particles having the first feature amount.

### CROSS REFERENCE TO RELATED APPLICATIONS

This application is a continuation of PCT Application No. PCT/JP2021/034395, filed Sep. 17, 2021, which claims priority to Japanese Patent Application No. 2020-165584, filed Sep. 30, 2020, the entire contents of each of which are hereby incorporated by reference in their entirety.

### TECHNICAL FIELD

The present invention relates to a method for reading an identification tag and a method for manufacturing an identification-tagged article.

### BACKGROUND

Japanese Patent Application JP 2003-511675 (hereinafter “Patent Literature 1”) describes a method of imaging colloidal rod particles as nano-barcodes. The method described in Patent Literature 1 identifies segmented nanoparticles each having segments distinguishable by reflectivity. The segmented nanoparticles have a length from 10 nm to 50 μm and a width from 5 nm to 50 μm. These nanoparticles are imaged or read.

Patent Literature 1 describes that the segments of the particles can be made of any material including a metal, an alloy, a metal alloy, a metal nitride, a metal chalcogenide, a metal oxide, a metal sulfide, a metal selenide, a metal telluride, polymeric materials, and crystalline or non-crystalline materials.

In Patent Literature 1, the nanoparticles having the segments (e.g., sequences) are used. That is, an information content is increased by increasing the number of sequences like a barcode.

By using the nanoparticles as in Patent Literature 1, information is imparted to an article, and the imparted information is read. The information imparted to the article may be various types of information such as a product number, a manufacturer, a manufacturing history, and lot display of the article.

A portion including the information imparted to the article by the nanoparticles as described above is also referred to as an identification tag, and the information included in the identification tag is referred to as tag information.

Preferably, the identification tag attached to the article preferably has an inconspicuous size so as not to impair the appearance of the article. The identification tag is sometimes attached to a small article. From such viewpoints, the identification tag needs to be small. As the identification tag having a small size, there are identification tags called a micro tag and a nano tag.

In the technique of Patent Literature 1, the information content included in the identification tag can be increased by increasing the number of sequences. However, if the number of sequences is to be increased when the identification tag requires a small size, it is necessary to form the sequences with a fine structure with high accuracy, which then increases the tag manufacturing cost.

On the other hand, in an identification method using the contingency of information of an identification target, such as object fingerprint authentication, it is necessary to accumulate a large amount of data in a reading system that reads the identification tag. This causes a problem of large load applied to the reading system.

### SUMMARY OF THE INVENTION

Accordingly, it is an object of the present invention to provide a method for reading an identification tag that reduces the size of the identification tag and the method enabling to read information included in the identification tag from information other than sequences (e.g., segments) of particles included in the identification tag.

In an exemplary aspect, a method is provided for reading an identification tag that includes detecting a content of particles having a first feature amount as a specific feature amount, the particles being included in the identification tag, and distinguishing a type of the identification tag by information on the content of the particles having the first feature amount.

In another exemplary aspect, a method for manufacturing an identification-tagged article is provided that includes manufacturing an article to which an identification tag is attached by attaching to the article a composition containing particles having a first feature amount as a specific feature amount so that a content of the particles included in the identification tag becomes a content corresponding to a type of the identification tag.

According to the exemplary aspects, the present invention provides the method for reading an identification tag that reduces the size of the identification tag. Moreover, the method facilitates the reading of information included in the identification tag from information other than sequences of particles included in the identification tag.

### BRIEF DESCRIPTION OF DRAWINGS

FIG. 1 is a schematic view illustrating an example of a microscopic image of an identification tag including particles.

FIG. 2 is a schematic view illustrating an example in which a content detection region of the image illustrated in FIG. 1 is binarized by image processing.

FIG. 3 is a schematic view for explaining an example of a method of detecting a content of particles by the number of pixels.

FIG. 4 is a schematic view for explaining another example of the method of detecting a content of particles by the number of pixels.

FIG. 5A is a schematic view illustrating an example of a microscopic image of an identification tag including fibrous particles.

FIG. 5B is a schematic view illustrating an example in which the image illustrated in FIG. 5A is binarized by image processing.

FIG. 5C is a schematic view illustrating an example in which Hough transform is performed on the image illustrated in FIG. 5B.

FIG. 6 is a schematic view illustrating an example in which particles are distinguished using circularity as a feature amount.

FIG. 7 is a schematic view illustrating an example in which particles are distinguished using circularity as a feature amount.

FIG. 8 is a schematic view illustrating another example of the microscopic image of the identification tag including particles.

FIG. 9 is a schematic view illustrating an example in which the identification tag is reduced in size.

FIG. 10 is a schematic view illustrating an example in which a barcode is reduced in size.

FIG. 11A is a schematic view illustrating an example in which the center of the identification tag is read as the content detection region.

FIG. 11B is a schematic view illustrating an example in which a corner of the identification tag is read as the content detection region.

FIG. 12A is a schematic view illustrating an example in which the center of the barcode is read.

FIG. 12B is a schematic view illustrating an example in which a corner of the barcode is read.

FIG. 13 is a perspective view schematically illustrating an example of an identification-tagged article.

FIG. 14 is a perspective view schematically illustrating another example of the identification-tagged article.

FIG. 15 is a perspective view schematically illustrating still another example of the identification-tagged article.

FIG. 16 is a perspective view schematically illustrating still another example of the identification-tagged article.

### DETAILED DESCRIPTION OF EMBODIMENTS

Hereinafter, a method for reading an identification tag and a method for manufacturing an identification-tagged article of the present invention will be described.

In general, it is noted that the present invention is not limited to the following configurations and modes, and changes can be appropriately applied thereto within a range not changing the gist of the present invention. The present invention also includes a combination of two or more of the individual preferred configurations and modes of the present invention described below.

In an exemplary aspect, a method for reading an identification tag is provided that includes detecting a content of particles having a first feature amount as a specific feature amount included in the identification tag, and distinguishing a type of the identification tag by information on the content of the particles having the first feature amount.

In an exemplary aspect, the identification tag can be an element from which some information can be read by distinguishing the type of the identification tag with a reading device. In the method for reading an identification tag of the exemplary aspect, the content of the particles included in the identification tag and having the first feature amount as the specific feature amount is an index indicating the type of the identification tag.

Examples of the information that can be included in the identification tag include a manufacturer of a product, product number display (e.g., a model number display), lot display (e.g., a serial number display), and manufacturing place display. Moreover, the reading device side can be configured to determine as what kind of information the content of the particles having the specific feature amount and included in the identification tag is read.

In general, a manufacturer or a distributor of an article uses the identification tag to impart information to the article, so that the identification tag can be used for determining the authenticity of the article. The identification tag used in such applications is also referred to as a security tag. The method for reading an identification tag of the present invention can also be used as a method for determining the authenticity of an article performed by reading the identification tag.

In an exemplary aspect, the identification tag includes particles. Whether the identification tag includes particles can be determined by observing the particles in a microscopic image of the identification tag that is obtained by a microscope or some similar type of image reader.

For purposes of this disclosure, the term “particles” is a concept including those having a granular shape such as spherical particles, oval-spherical particles, columnar particles, cone particles, polyhedral particles, layered particles, and amorphous particles, and those having a fibrous shape, and also includes those having a relatively large aspect ratio. It is only necessary that an object boundary can be distinguished in the microscopic image. It is also noted that the concept of “particles” does not include those uniformly spread in a planar shape in the microscopic image to make it impossible to distinguish the object boundary.

The particles having the first feature amount preferably and included in the identification tag have a size that is not visible by observation with the naked eye. For example, the particles preferably have an average particle size between 0.2 and 100 μm, inclusive, more preferably between 0.2 and 10 μm, inclusive.

The average particle size of the particles can be determined as an average value of the particle sizes of the particles having the first feature amount included in the microscopic image. The particle sizes of the particles can be obtained by image analysis as equivalent circle diameters of the particles. In a case where a plurality of particles included in the identification tag are connected by sintering or the like, the particle size of each particle can be determined after performing region division by a known image analysis method (e.g., a watershed method) to distinguish boundaries of the particles.

Moreover, the size visible by observation with the naked eye varies depending on a particle shape. In a case where the particles are granular, the average particle size of the particles is preferably in the above range. In a case where the particles are fibrous, an average fiber diameter thereof is preferably between 0.2 and 100 μm, inclusive, more preferably between 0.2 and 10 μm, inclusive.

Moreover, in an exemplary aspect, the particles having the first feature amount used for the identification tag are preferably particles containing a metal. Examples of the metal-containing particles include metal particles, such as single metal particles or metal alloy particles. Examples of the metal particles include copper, silver, nickel, and tin particles, or alloy particles of these metals. As the metal particles, coated powder obtained by coating particles of a first metal with a second metal can also be used.

The particles having the first feature amount used for the identification tag are preferably particles containing a metal oxide, a metal nitride, or a metal carbide.

Examples of the metal oxide-containing particles (e.g., metal oxide particles) include barium titanate, alumina, titanium oxide, ferrite, lead zirconate titanate, strontium titanate, forsterite, zirconium oxide, steatite, cordierite, sialon, and silica.

Examples of the metal nitride-containing particles (e.g., metal nitride particles) include silicon nitride and aluminum nitride.

Examples of the metal carbide-containing particles (e.g., metal carbide particles) include silicon carbide.

In these examples, silicon is regarded as a metal for purposes of this disclosure.

When the particles are the metal-containing particles or the metal oxide, metal nitride, or metal carbide-containing particles, the particle shape does not change over a long period of time because of their excellent abrasion resistance and excellent environmental resistance, such as heat resistance, light resistance, acid resistance, and the like. Therefore, the particles are configured to function as the identification tag over a long period of time.

Resin particles can also be used as the particles having the first feature amount. When the resin particles are used, the identification tag can be manufactured at low cost. The use of the resin particles is preferable when the period of use as the identification tag is short. Examples of the resin particles include polyolefin particles (e.g., polyethylene particles, polypropylene particles, etc.), polyester particles (e.g., PET particles, etc.), fluororesin particles (e.g., PTFE particles, etc.), silicone resin particles, and acrylic resin particles.

In the method for reading an identification tag of the present invention, it is preferable to detect the content of the particles having the first feature amount from an image of the identification tag.

The method of using the image of the identification tag can use an existing imaging device (e.g., an optical microscope, an electron microscope, a hyperspectral camera, etc.) as the device for reading the identification tag, and does not require a dedicated reading device.

In an exemplary aspect, the method can also be compatible with processing by a method such as machine learning or deep learning that handles image data, making it possible to mechanically read the identification tag. It is also possible to adjust a computation amount (e.g., a load) on the reading system side by controlling the type of image processing to be applied.

Suppose that, as the identification tag, an ink containing the particles having the first feature amount as the specific feature amount is manufactured by uniformly dispersing the particles in a paste containing a resin or a solvent by a dispersion technique, and an article is manufactured by applying the ink to a target such as a glass plate. An exemplary embodiment of the identification tag will be described referring to an example in which this article is observed with an electron microscope.

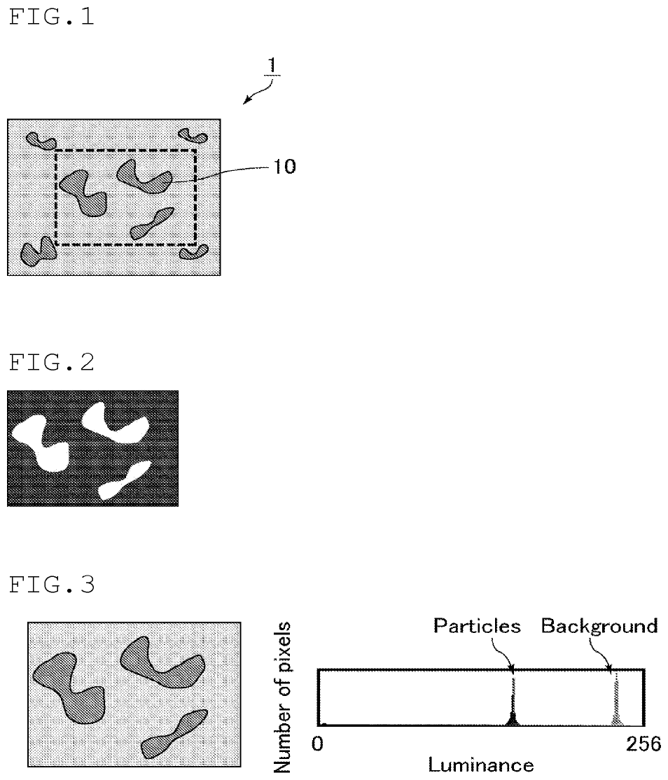

FIG. 1 is a schematic view illustrating an example of the microscopic image of the identification tag including the particles.

An image 1 of the identification tag illustrated in FIG. 1 shows a plurality of particles 10.

All the particles 10 in FIG. 1 are the particles having the first feature amount as the specific feature amount. A user of the identification tag can optionally determine how to determine the specific feature amount. An example of a method for distinguishing whether the particles are the particles having the specific feature amount or particles not having the specific feature amount will be described later.

A certain range in the microscopic image is defined as a region where the content of the particles is detected (e.g., a “content detection region”). The content detection region in FIG. 1 is surrounded by a dotted line. When the particles are uniformly distributed in the identification tag, the content of the particles has substantially the same value regardless of where the content detection region is set.

There are several methods of detecting the content of the particles.

By counting the number of particles having the specific feature amount and included in the image, the content of the particles having the specific feature amount can be detected.

By counting the number of particles having the first feature amount and included in the image, the content of the particles having the first feature amount can be detected.

With the method of counting the number of particles, the computation amount (e.g., load) of image processing on the reading system side can be reduced.

Binarization processing may be performed in counting the number of particles included in the image.

FIG. 2 is a schematic view illustrating an example in which the content detection region of the image illustrated in FIG. 1 is binarized by image processing.

In this exemplary aspect, the number of white regions in the binarized image is counted. The number of white regions is the number of particles per content detection region. It can be seen that there are three particles in FIG. 2.

When this method is adopted, the content of the particles included in the content detection region in FIG. 1 is “3”.

The type of the identification tag is distinguished using the numerical information of the content of the particles obtained in the above procedure.

In the reading device, a library is stored in advance in which the content of the particles and the type of the identification tag are associated with each other.

A case where an ID (e.g., an “ID number”) is associated as the type of the identification tag will be described as an example. Suppose that the content of the particles and the ID are associated as follows.

ID: 1 equals when the content of the particles is 1 to 2

ID: 2 equals when the content of the particles is 3 to 4

ID: 3 equals when the content of the particles is 5 or more

In this case, since the content of the particles included in the content detection region in FIG. 1 is “3”, the ID of the identification tag is read to be 2.

As the method of detecting the content of the particles, there is also a method of detecting the content of the particles having the specific feature amount by the number of pixels included in the image and related to the particles having the specific feature amount and the number of pixels included in the image and related to a background of the image.

The number of pixels included in the image and related to the particles having the first feature amount and the number of pixels included in the image and related to the background of the image can be used to detect the content of the particles having the first feature amount.

In the method of using the number of pixels, detection accuracy is improved as compared with that in the method of counting the number of particles. Even in a case where it is difficult to accurately count the number of particles due to the particles overlapping each other on the image, the content of the particles can be detected.

FIG. 3 is a schematic view for explaining an example of the method of detecting the content of the particles by the number of pixels.

In this method, the image is gray-scaled to acquire a luminance distribution.

In an image illustrated on the left side of FIG. 3, the particles are captured in a color close to black, and the background is captured in a color close to white. Moreover, an image processor (or similar device) can be configured to convert the image into 256 gray scale for each luminance, and a chart is created in which the vertical axis represents the number of pixels of the particles and the horizontal axis represents the luminance.

In this chart, the left peak is a peak of pixels derived from the particles, and the right peak is a peak of pixels derived from the background. The numbers of pixels included in both the peaks are individually counted and a ratio thereof is obtained. The ratio (%) of the particles can be obtained by the following formula.

Ratio (%) of particles=[number of pixels of particles]/[number of pixels of particles+number of pixels of background]

The ratio (%) of the particles determined as described above is used as the content of the particles.

Suppose that the ratio of the particles included in the image illustrated in FIG. 3, that is, the content of the particles is 30%.

Suppose that the content of the particles and the ID are associated as follows.

ID: 1 equals when the content of the particles is more than 0% and less than 20%

ID: 2 equals when the content of the particles is 20% or more and less than 40%

ID: 3 equals when the content of the particles is 40% or more

In this case, since the content of the particles included in the content detection region in FIG. 3 is “30%”, the ID is read to be 2.

The ID associated with the index used as the content of the particles can be optionally determined.

In the above two examples, the ID is read to be 2 in both the case of counting the number of particles and the case of using the number of pixels. However, the IDs to be read are not necessarily the same.

Depending on the association between the index used as the content of the particles included in the identification tag and the ID, different IDs may be read even for the same particles.

For example, when there are a plurality of identification tags having the same number of particles, the size of each particle does not affect the content of the particles in the method of counting the number of particles, while the proportion of the particles increases as the size of one particle increases, and thus the content of the particles also increases in the method of using the number of pixels. Therefore, it should be appreciated that the contents of the particles obtained by these two methods do not always coincide with each other.

As the method of detecting the content of the particles by the number of pixels, there is also a method of dividing the image into RGB components to acquire a luminance distribution other than the method of gray-scaling the image to acquire the luminance distribution. In the case of this method, it is preferable to use an imaging device configured to determine a color image, such as an optical microscope or a hyperspectral camera. Hereinafter, for comparison explanation, a case where an image illustrated on the left side of FIG. 3 is acquired as a color image will be described as an example.

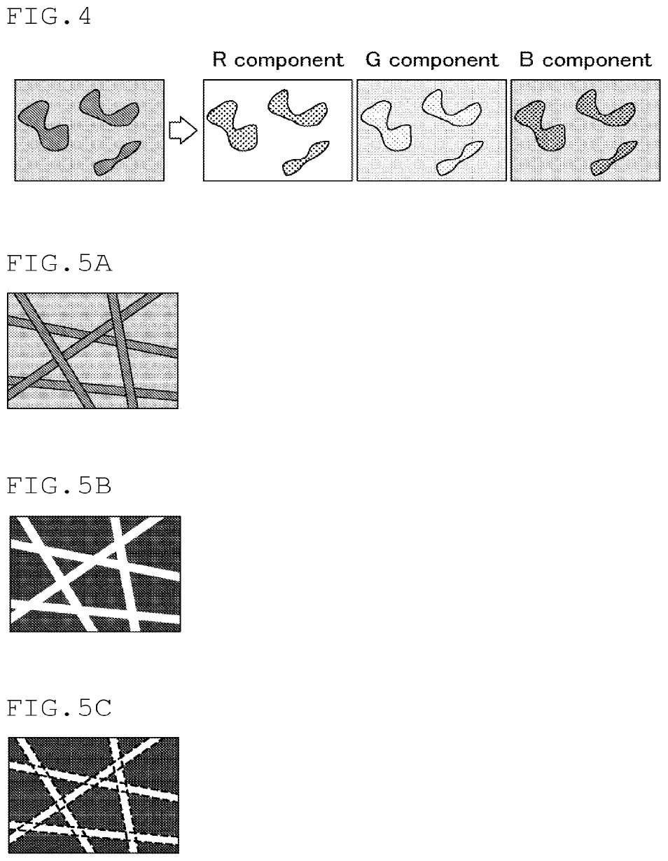

FIG. 4 is a schematic view for explaining another example of the method of detecting the content of the particles by the number of pixels.

In this method, the image is divided into RGB components to acquire the luminance distribution.

The image illustrated on the left side of FIG. 4 is a color image. This color image is divided into R components (i.e., red components), G components (i.e., green components), and B components (i.e., blue components) as illustrated on the right side of FIG. 4.

By image processing of extracting only the R component, the G component, and the B component included in each pixel, an image (e.g., an R image) of only the R components, an image (e.g., a G image) of only the G components, and an image (e.g., a B image) of only the B components can be obtained.

Since the specification cannot be displayed in color, each image in FIG. 4 is not displayed in color.

The number of pixels in the particles is counted for each of the R image, the G image, and the B image.

In the example of the R image, the following formula is used. The same applies to the G image and the B image.

Ratio (%) of particles in R image=[Number of pixels of particles in R image]/[Total of number of pixels of particles and number of pixels of background in R image]

The ratio (%) of the particles in each of the R image, the G image, and the B image determined as described above is used as the content of the particles. That is, three kinds of values are obtained as the content of the particles.

In the reading device, the content of the particles and the ID are associated with each other. At the time of association, only one kind may be used as the content of the particles, or any combination of the three kinds may be used as the content of the particles.

In a case where the particles included in the identification tag are fibrous, the content of the particles can also be detected.

FIG. 5A is a schematic view illustrating an example of a microscopic image of an identification tag including fibrous particles, FIG. 5B is a schematic view illustrating an example in which the image illustrated in FIG. 5A is binarized by image processing, and FIG. 5C is a schematic view illustrating an example in which Hough transform is performed on the image illustrated in FIG. 5B.

When using the fibrous particles, the method of using the number of pixels described above can be applied as the method of detecting the content of the particles.

Moreover, the content of the particles can be obtained by gray-scaling the image illustrated in FIG. 5A to acquire a luminance distribution.

The content of the particles can also be obtained by dividing the image into RGB components to acquire a luminance distribution.

When the method of counting the number of particles is used as the method of detecting the content of the particles with respect to the fibrous particles, it is difficult to count the number of fibers as it is since white lines indicating the fibers intersect in the binarized image illustrated in FIG. 5B. In this case, the Hough transform as illustrated in FIG. 5C is performed to detect a straight line in the image. The content of the particles can be obtained by counting the number of straight lines.

Next, an example of the method for distinguishing whether the particles shown in the image are the particles having the specific feature amount or the particles not having the specific feature amount will be described.

For purposes of this disclosure, the “specific feature amount” is a feature amount that can be optionally determined by a manufacturer or a user of the identification tag. Examples thereof include an index obtained by quantifying the particle shape included in the identification tag with a specific index and an index qualitatively indicating the particle shape.

One feature amount focused and selected by the manufacturer or the user of the identification tag from these feature amounts is set as the first feature amount.

However, it is not preferable to use a particle sequence obtained by intentionally sequencing a plurality of particles, as the specific feature amount. This is because it is difficult to control the particle sequence in a fine region, making it difficult to manufacture the identification tag. When the particle sequence is used as the specific feature amount, it is necessary to recognize a start point and an end point of the sequence, making it difficult to set the content detection region.

As the index obtained by quantifying the particle shape, a circularity, an aspect ratio, an envelope degree, and the like can be used.

The circularity is an index indicated by “circularity=4πS/L² (S is an area, and L is a perimeter)”. The circularity is 1 in the case of a perfect circle, and the circularity closer to 1 means that the circularity is closer to the perfect circle.

The aspect ratio is an index indicated by a ratio of a long axis/a short axis of a figure.

The envelope degree is an index indicated by “envelope perimeter/actual perimeter”.

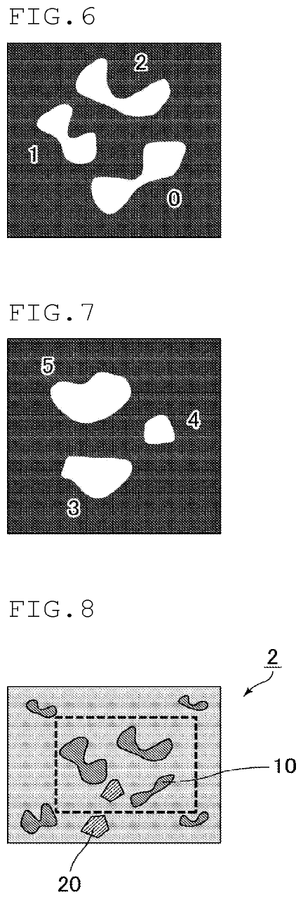

FIG. 6 and FIG. 7 are schematic views illustrating examples in which the particles are distinguished using the circularity as the feature amount.

FIG. 6 and FIG. 7 illustrate examples in which an electron microscopic image is binarized by image processing.

It is determined in advance in which range the circularity is to be distinguished as the “particles having the specific feature amount”. In this example, when the circularity=0.5 or less, it is distinguished as the “particles having the specific feature amount”.

FIG. 6 shows three particles. These particles are set to numbers 0, 1, and 2, and a perimeter and an area of each particle are obtained on image processing software.

The particle 0 is measured to have a perimeter of 900 pixels, and an area of 25000 pixels. Since the circularity obtained from this information is about 0.4, the particle is distinguished as the particle having the specific feature amount.

The particle 1 is measured to have a perimeter of 700 pixels and an area of 15000 pixels. Since the circularity obtained from this information is about 0.4, the particle is distinguished as the particle having the specific feature amount.

The particle 2 is measured to have a perimeter of 850 pixels and an area of 20000 pixels. Since the circularity obtained from this information is about 0.4, the particle is distinguished as the particle having the specific feature amount.

That is, all the three particles in FIG. 6 are distinguished as the “particles having the specific feature amount”.

FIG. 7 shows three particles. These particles are set to numbers 3, 4, and 5, and a perimeter and an area of each particle are obtained on image processing software.

A particle 3 is measured to have a perimeter of 600 pixels and an area of 20000 pixels. Since the circularity obtained from this information is about 0.7, the particle is distinguished as the particle not having the specific feature amount.

A particle 4 is measured to have a perimeter of 300 pixels and an area of 7000 pixels. Since the circularity obtained from this information is about 1.0, the particle is distinguished as the particle not having the specific feature amount.

A particle 5 is measured to have a perimeter of 650 pixels and an area of 25000 pixels. Since the circularity obtained from this information is about 0.7, the particle is distinguished as the particle not having the specific feature amount.

That is, all the three particles in FIG. 7 are distinguished as the “particles not having the specific feature amount”.

Examples of the index qualitatively indicating the particle shape include an index indicating, when the shape is expressed in words, which category of a spherical particle, an oval-spherical particle, a columnar particle, a cone particle, a polyhedral particle, a layered particle, an amorphous particle, a fibrous particle, and the like the particles belong to.

When such an index is used, analysis using artificial intelligence may be used in image processing according to an exemplary aspect. For example, a learned model obtained by using an image including a specific particle shape (for example, an oval-spherical particle) as training data is created in advance, and an image as a target of image processing is input to the learned model, whereby it is possible to distinguish whether or not particles shown in the image are the specific particle (i.e., the oval-spherical particles). In addition, processing by a convolutional neural network may also be used as preprocessing of the analysis using artificial intelligence.

As another specific feature amount, reflection information of a particle surface using a polarizing filter or the like observed using an optical microscope can also be used.

When the identification tag is read, an operator may visually observe the image to distinguish whether the particles are the particles having the specific feature amount. The operator performs the visual observation particularly when the particles are distinguished using the index qualitatively indicating the particle shape. In this case, the operator may determine whether the particles are the particles having the specific feature amount from the particle shape on the basis of his/her own criteria. In an example, suppose that the particles having the specific feature amount are defined as a “spherical particle”. In a case where both the spherical particle and a non-spherical particle are present in the image, a mode can be considered in which the operator manually performs an operation of extracting the spherical particle from the image on the basis of his/her own criteria.

In the method for reading an identification tag of the exemplary aspects, a method may be adopted in which the image of the identification tag is not used in detecting the content of the particles having the first feature amount. Examples of the method of detecting the content of the particles having the first feature amount without using the image include a detection method using the intensity of fluorescence reflection.

In the method for reading an identification tag of the exemplary aspects, an analysis device that analyzes physicochemical properties of components included in the identification tag may be used, and the type of the identification tag may be distinguished by further information on the physicochemical properties.

Examples of the physicochemical properties of the components included in the identification tag include a physicochemical property of particles included in the identification tag and a physicochemical property of a component other than the particles included in the identification tag.

By the further information on the physicochemical properties of the components included in the identification tag, the number of tag types included in the identification tag can be further increased.

Examples of the information on the physicochemical property of the particles included in the identification tag include information regarding composition and/or a crystal structure of the particles.

Examples of the information regarding the composition of the particles include elemental analysis results of elements constituting the particles.

As a method for performing elemental analysis, a method such as elemental analysis by EDX, elemental analysis by WDS, elemental analysis by XRF, Raman spectroscopy, or elemental analysis by ICP can be used according to various exemplary aspects.

Moreover, a device is preferably used in which an imaging device and an element analyzer are combined, such as SEM-EDX, because the analysis of the particle shape and the analysis of the composition and/or crystal structure of the particles can be performed simultaneously.

Examples of the information regarding the crystal structure of the particles include information regarding a crystallization rate of the particles, a full width at half maximum for a specific diffraction angle, and a phase. As a method of crystal structure analysis, analysis by XRD, Raman spectroscopy, UV-VIS spectral analysis, and the like can be used.

Analysis by a fluorescence spectrophotometer may also be performed.

The elemental analysis may be performed on an identification tag separated from an article to which the identification tag is attached. Some type of analysis needs to be performed by preparing a solution containing the particles included in the identification tag, which results in a destructive inspection of the identification tag.

It is noted that the physicochemical property of the component other than the particles included in the identification tag can also be measured by the same method as the measurement of the physicochemical property of the particles included in the identification tag.

A color property may also be used as the information on the physicochemical property. For example, information regarding the color property can be obtained by performing photographing using a hyperspectral camera.

In the method for reading an identification tag of the exemplary aspects, the presence or absence of components having a second feature amount as the specific feature amount and included in the identification tag may be further detected. The type of the identification tag may be distinguished by further information on the presence or absence of the components having the second feature amount.

The second feature amount is the specific feature amount, but is a feature amount different from the first feature amount. The second feature amount can be determined by being focused and selected on the basis of criteria different from the first feature amount by the manufacturer or the user of the identification tag.

The components having the second feature amount may have a particulate shape or may not have a particulate shape. The components having the second feature amount are preferably particles having the second feature amount.

The components having the second feature amount may have the first feature amount or may not have the first feature amount. The components having the second feature amount are preferably components not having the first feature amount.

When the components having the second feature amount are the components not having the first feature amount, the components can be easily distinguished from the particles having the first feature amount.

When the components having the second feature amount have the first feature amount and included in the identification tag, particles having both the first feature amount and the second feature amount are present in the identification tag.

In this case, the identification tag can include the particles having both the first feature amount and the second feature amount, the particles having the first feature amount, but not having the second feature amount, and/or the components not having the first feature amount, but having the second feature amount. The type of the identification tag can be distinguished by the information on the presence or absence of the plurality of types of components and information on a content of the respective components.

When the components having the second feature amount are present, the content of the components having the second feature amount may be further detected, and the type of the identification tag may be distinguished by further information on the content of the components having the second feature amount.

By using the components having the second feature amount in addition to the particles having the first feature amount, the number of tag types can be easily increased.

FIG. 8 is a schematic view illustrating another example of the microscopic image of the identification tag including the particles.

An image 2 of the identification tag illustrated in FIG. 8 shows a plurality of particles 10. The particles 10 are the same particles having the first feature amount as the particles in FIG. 1 as described above. The image 2 of the identification tag shows particles 20 having the second feature amount.

The particles 20 are particles distinguished by an index different from the index indicating whether the particles are the particles having the first feature amount.

For example, suppose that the particles 10 having the first feature amount are particles having a specific circularity (e.g., a circularity of 0.5 or less). On the other hand, suppose that the particles 20 having the second feature amount are particles having a specific area (e.g., an area of 17000 pixels or more) regardless of their circularity.

The particles 20 illustrated in FIG. 8 do not have a circularity of 0.5 or less and thus do not fall under the particles having the first feature amount, but have an area of 17000 pixels or more and thus fall under the particles having the second feature amount.

Among the particles 10 having the first feature amount illustrated in FIG. 8, the particles having an area of 17000 pixels or more also fall under the particles having the second feature amount. On the other hand, among the particles 10 having the first feature amount, the particles having an area of less than 17000 pixels do not fall under the particles having the second feature amount.

The content of the components having the second feature amount and included in the image of the identification tag can be detected by a method similar to the detection of the content of the particles having the specific feature amount (e.g., the detection of the content of the particles having the first feature amount) described above.

The detection of the content of the particles having the first feature amount and the detection of the content of the components having the second feature amount, included in the image, may be performed simultaneously or individually for each particle.

For example, the content of the particles having the first feature amount is measured by detecting (e.g., scanning) the content of the particles having the first feature amount, and subsequently, the content of the components having the second feature amount is measured by detecting (e.g., scanning) the content of the components having the second feature amount. Through this procedure, the content of the particles having the first feature amount and the content of the components having the second feature amount are obtained. The particles having both the first feature amount and the second feature amount are counted in each measurement.

The number of tag types included in the identification tag can be increased by the information on the content of the components having the second feature amount and included in the identification tag.

For example, the number of types of the information included in the identification tag is the (number of types of the information on the content of the particles having the first feature amount)×(number of types of the information on the content of the components having the second feature amount).

The respective contents can be combined and associated with the ID by, for example, when the content of the particles having the first feature amount is “3”, setting the ID to 4 when the content of the components having the second feature amount is “1”, and the ID to 5 when the content of the components having the second feature amount is “2”.

In addition to the detection of the components having the second feature amount, components having another specific feature amount may be further detected. A focused feature amount can be selected and determined as components having a third feature amount, components having a fourth feature amount, and so forth, similarly to the components having the second feature amount.

By increasing the number of types of the particles or the components included in the identification tag and whose content information is used, the number of tag types included in the identification tag can be further increased.

In the method for reading an identification tag of the present invention, in a case where article infringement determination is performed, first-stage authentication may be performed by detecting that the particles having the first feature amount as the specific feature amount are present, and second-stage authentication may be performed by detecting that the content of the particles having the first feature amount is within a specific range. When the two-stage authentication is performed, other companies cannot imitate the identification tag only by causing the identification tag to include the particles having the first feature amount. Consequently, it is possible to manufacture the identification tag (e.g., a security tag) that is more difficult to imitate.

It should also be appreciated that the identification tag used in the method for reading an identification tag can be easily downsized according to exemplary aspects.

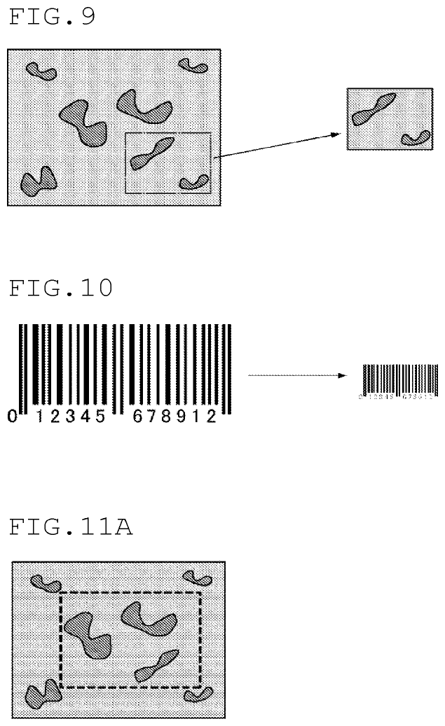

FIG. 9 is a schematic view illustrating an example in which the identification tag is reduced in size.

A large identification tag is illustrated on the left side of FIG. 9, and a small identification tag is illustrated on the right side thereof.

In both the identification tags illustrated on the left side and the right side of FIG. 9, the content of the particles having the specific feature amount per unit area of the content detection region is the same. In a case where the size of the identification tag is reduced, a process for reducing the particle size is not performed.

In the method for manufacturing an identification-tagged article of the present invention to be described later, the size of the identification tag can be reduced within a range in which the content of the particles included in the content detection region can be measured.

FIG. 10 is a schematic view illustrating an example in which a barcode is reduced in size.

In a case where information is displayed by a sequence like a barcode, it is necessary to downsize the entire identification tag. Therefore, it is technically difficult to reduce the size of the identification tag, resulting in an increase in cost required for manufacturing. Similarly, in a case of segmented nanoparticles as described in Patent Literature 1, it is technically difficult to reduce the size of the identification tag, resulting in an increase in cost required for manufacturing.

The identification tag used in the method for manufacturing an identification-tagged article of the exemplary aspects of the present invention to be described later is advantageous in that such a disadvantage does not occur.

It is not necessary to read the entire identification tag used in the method for reading an identification tag of the present invention as long as a range to which the identification tag is attached is read. Even when a part of the identification tag is read, the type of the identification tag can be distinguished by the information on the content of the particles having the first feature amount.

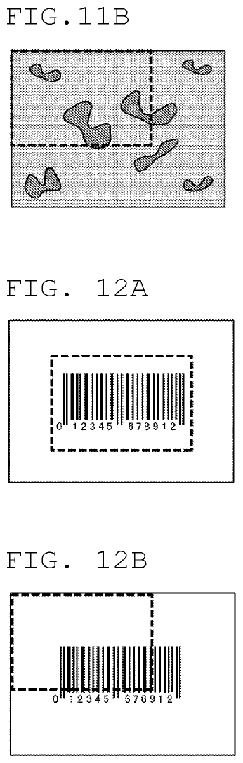

FIG. 11A is a schematic view illustrating an example in which the center of the identification tag is read as the content detection region, and FIG. 11B is a schematic view illustrating an example in which a corner of the identification tag is read as the content detection region.

The contents of the particles read in FIG. 11A and FIG. 11B are the same. That is, by reading the content of the particles having the first feature amount in a partial region in the identification tag, the identification tag can be accurately read. In which part of the identification tag the content is read does not affect the reading result.

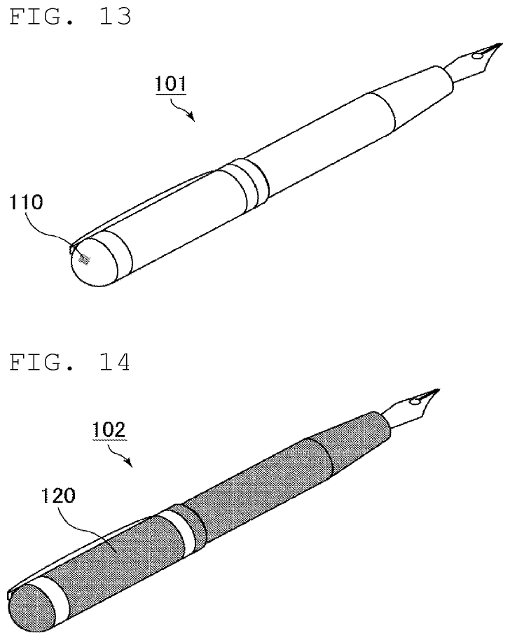

FIG. 12A is a schematic view illustrating an example in which the center of the barcode is read, and FIG. 12B is a schematic view illustrating an example in which a corner of the barcode is read.

In the case of the barcode, the entire sequence included in the barcode needs to be read. Therefore, it is possible to perform accurate reading when reading is performed so that the entire barcode is included as illustrated in FIG. 12A, while it is not possible to perform accurate reading when only a part of the barcode is read as illustrated in FIG. 12B.

Comparing the above examples, it can be said that the method for reading an identification tag of the exemplary aspects of the present invention is excellent in reading workability in that it is not necessary to accurately position a reading position to perform reading.

In the method for reading an identification tag as described herein, the identification tag is preferably obtained by applying an ink containing the particles having the first feature amount to an article.

The identification tag is preferably obtained by sticking a sticking object on an article. The particles having the first feature amount are attached to the sticking object.

The article to which the identification tag is attached is referred to as an identification-tagged article. Hereinafter, an example of the identification-tagged article as a target from which the identification tag is read using the method for reading an identification tag of the present invention will be described.

FIG. 13 is a perspective view schematically illustrating an example of the identification-tagged article (e.g., a fountain pen).

An identification-tagged article 101 illustrated in FIG. 13 includes an identification tag 110 in which the ink containing the particles is applied by printing to a part of a fountain pen as the article.

The identification tag 110 includes the particles having the first feature amount.

It is noted that a method of applying the ink containing the particles is not limited to printing, and examples thereof include a method of bringing a part of the article into contact with the ink containing the particles, and a method of application by brush coating or the like.

Since the particles contained in the ink are the particles having the first feature amount as the specific feature amount, the information can be imparted to the article by the identification tag.

In a case where a small identification tag is attached to a specific position of the article as illustrated in FIG. 13, the influence of the identification tag on the appearance (e.g., the design) of the article can be reduced.

Although FIG. 13 illustrates the example in which the small identification tag is attached to the specific position of the article, the identification tag may be attached to a wider range of the article.

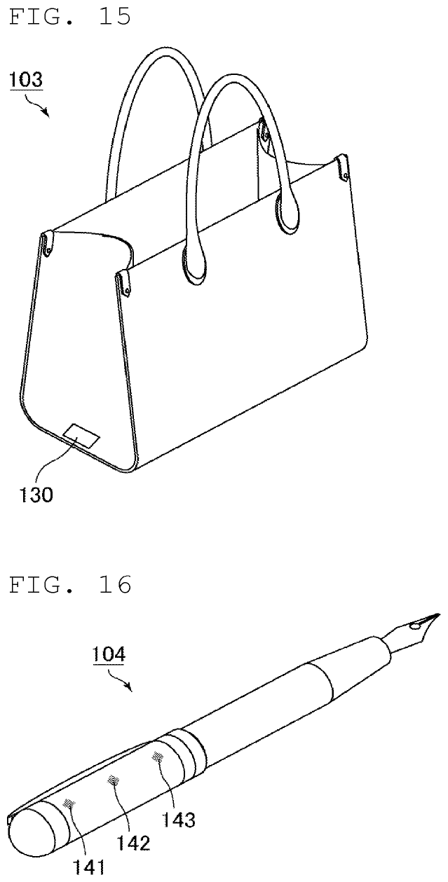

FIG. 14 is a perspective view schematically illustrating another example of the identification-tagged article.

An identification-tagged article 102 illustrated in FIG. 14 has an identification tag 120 in which the ink containing the particles is applied by printing over a wide range of a fountain pen as the article.

When the identification tag is applied to the wide range of the article, it is not necessary to pay attention to which part of the article is set as the reading position in reading the identification tag. This makes it possible to prevent a reading failure of the identification tag due to positional deviation of the reading position.

The identification tag may be obtained by sticking the sticking object on the article. The particles having the first feature amount are attached to the sticking object.

FIG. 15 is a perspective view schematically illustrating still another example of the identification-tagged article.

An identification-tagged article 103 illustrated in FIG. 15 includes an identification tag 130 in which the sticking object including the particles is stuck on a part of a bag as the article.

It is possible to obtain the identification-tagged article by attaching the particles to the sticking object and sticking the sticking object as the identification tag on the article.

As the sticking object, a sticker (e.g., a seal) in which the particles having the first feature amount are attached to one surface side of a base material and an adhesive or a pressure-sensitive adhesive is applied to the other surface side can be used. When the article is a fibrous product, such as a bag, clothing, or the like, the identification tag may be attached by sewing a fabric to the article as the sticking object. The ink containing the particles is attached to the fabric. The fabric to which the ink containing the particles is applied in such an application method falls under the sticking object.

The ink containing the particles having the first feature amount used for attaching the identification tag to the article can be manufactured by mixing the particles having the first feature amount with a solvent, a dispersant, a binder resin, and the like.

Moreover, it should be appreciated that the identification tag may be disposed at a position where the identification tag is easily visually recognized in the appearance of the article, or may be disposed at a position where the identification tag is hardly visually recognized (i.e., cannot be visually recognized) from the appearance of the article.

When the identification tag is used as a security tag, the identification tag is disposed at a position where the identification tag is easily visually recognized in the appearance of the article, so that a third party who intends to manufacture a counterfeit product needs to counterfeit the identification tag as well. The idea is to prevent imitation by clearly showing that the identification tag is attached.

On the other hand, by disposing the identification tag at a position that is difficult to visually recognize (e.g., not visible) in the appearance of the article, the influence of the identification tag on the appearance (i.e., the design or ornamental aspect) of the article can be eliminated. If a third party who intends to manufacture a counterfeit product is not aware of the presence of the identification tag, the third party does not imitate the article including the portion of the identification tag, so that a complete counterfeit product including the identification tag is not manufactured.

In general, the identification tag may be attached to any article including products that are likely to be imitated or forged. Examples thereof include brand-name products (bags, wallets, jewelry, cosmetics, wristwatches, clothing, stationery, etc.), CDs, DVDs, game software, toys, pharmaceuticals, medical devices, banknotes, electronics, substrates, modules, electrical appliances, cameras, OA equipment, furniture, and conveyance materials and packing materials for various products.

The identification-tagged article may be provided with the identification tags at a plurality of positions.

For example, the identification-tagged article may be an identification-tagged article in which the identification tags each including the particles having the specific feature amount are attached to a plurality of positions, and the contents of the particles having the specific feature amounts included in the identification tags at the plurality of positions are different from each other.

FIG. 16 is a perspective view schematically illustrating still another example of the identification-tagged article.

An identification-tagged article 104 illustrated in FIG. 16 includes identification tags 141, 142, and 143 in which the ink containing the particles is applied by printing over a wide range of a fountain pen as the article.

The identification tags attached to three positions of the article are individually read, and the type of the identification tag is distinguished from the content of the particles included in each of the identification tags.

The contents of the particles included in the identification tags at the plurality of positions may be read as a permutation by specifying the reading order, or may be read as a combination by not specifying the reading order. The reading method can be optionally determined in the reading device.

By providing the identification tags at the plurality of positions, the number of tag types can be increased.

Next, the method for manufacturing an identification-tagged article of an exemplary aspect of the present invention, which is a method enabling to manufacture the identification-tagged article, will be described.

The method for manufacturing an identification-tagged article includes manufacturing an article to which an identification tag is attached by attaching to the article a composition containing particles having a first feature amount as a specific feature amount so that a content of the particles included in the identification tag becomes a content corresponding to a type of the identification tag.

The type of the identification tag to be attached can be changed in a plurality of ways by preparing the particles having the first feature amount as the specific feature amount in advance and changing an amount of the particles attached to the article. Even when there is only one type of particle, it is possible to manufacture a plurality of types of identification tags by changing the attachment amount of the particles, making it easy to manufacture the identification-tagged article.

In the preparation of the particles having the first feature amount, an operation of making the particle size even by classifying the particles or an operation of adjusting the particle size by grinding the particles can be performed.

Alternatively, an operation of heat-treating the particles to join the particles together may be performed.

In exemplary aspects, the particle shape can be adjusted by adjusting conditions of heat treatment, grinding, classification, and the like of the particles.

The composition containing the particles having the first feature amount used for attaching the identification tag to the article can be manufactured by mixing the particles having the first feature amount with a solvent, a dispersant, a binder resin, and the like.

The particles not having the first feature amount may be mixed with the composition. The components having the second feature amount may also be mixed therewith.

During manufacturing of this composition, the content of the particles having the first feature amount (e.g., particle concentration in the composition) is adjusted. When the particle concentration in the composition is increased, the content of the particles having the first feature amount and included in the identification tag is increased.

The content of the particles having the first feature amount and included in the identification tag can also be adjusted by adjusting an attachment amount (e.g., a thickness) of the composition attached to the article.

It is noted that the method of attaching the composition containing the particles to the article is not limited to printing, and examples thereof include a method of bringing a part of the article into contact with the composition containing the particles, and a method of application by brush coating or the like.

In the method for manufacturing an identification-tagged article of the exemplary aspect, the composition is preferably an ink as described above in which the particles having the first feature amount are dispersed at a predetermined concentration, and the ink is preferably applied to the article.

The use of the ink in which the particles are dispersed in the composition at a predetermined concentration makes it easy to attach the identification tag to the article.

The composition is more preferably an ink in which the particles are dispersed at a uniform concentration. Dispersing the particles in the ink at a uniform concentration makes the content of the particles in the identification tag even at any position of the identification tag when the ink is applied to the article. This configuration improves detection accuracy of the content of the particles. This configuration also contributes to downsizing of the identification tag.

### REFERENCE SIGNS LIST

1, 2 image of identification tag
10 particle having first feature amount
20 particle having second feature amount
101, 102, 103, 104 identification-tagged article
110, 120, 130, 141, 142, 143 identification tag

What is claimed:

1. A method for reading an identification tag, the method comprising:
reading the identification tag to detect a content of particles having a first feature amount as a specific feature amount; and
distinguishing a type of the identification tag based on information relating to the detected content of the particles having the first feature amount.

2. The method for reading an identification tag according to claim 1, further comprising:
reading the identification tag to detect a presence or an absence of a component having a second feature amount as the specific feature amount; and
distinguishing the type of the identification tag based on information relating to the presence or absence of the component having the second feature amount.

3. The method for reading an identification tag according to claim 2, wherein the component having the second feature amount is a component not having the first feature amount.

4. The method for reading an identification tag according to claim 2, wherein the component having the second feature amount is particles having the second feature amount.

5. The method for reading an identification tag according to claim 2, further comprising:
detecting a content of the component having the second feature amount, and
distinguishing the type of the identification tag based on information relating to the content of the component having the second feature amount.

6. The method for reading an identification tag according to claim 1, wherein the content of the particles having the first feature amount is detected from an image of the identification tag.

7. The method for reading an identification tag according to claim 6, further comprising detecting the content of the particles having the first feature amount by counting a number of the particles included in the image that have the first feature amount.

8. The method for reading an identification tag according to claim 6, further comprising detecting the content of the particles having the first feature amount based on a number of pixels related to the particles having the first feature amount that are included in the image and a number of pixels related to a background of the image.

9. The method for reading an identification tag according to claim 1, further comprising analyzing, by an analysis device, a physicochemical property of a component included in the identification tag.

10. The method for reading an identification tag according to claim 9, further comprising distinguishing the type of the identification tag based on the physicochemical property.

11. The method for reading an identification tag according to claim 1, further comprising applying an ink containing the particles having the first feature amount to an article to provide the identification tag.

12. The method for reading an identification tag according to claim 1, further comprising:
sticking a sticking object on an article; and
attaching the particles having the first feature amount to the sticking object to provide the identification tag.

13. The method for reading an identification tag according to claim 1, wherein the particles having the first feature amount are particles having an average particle size between 0.2 μm and 100 μm.

14. The method for reading an identification tag according to claim 11, further comprising preparing the ink by mixing the particles having the first feature amount with at least one of a solvent, a dispersant, and a binder resin.

15. The method for reading an identification tag according to claim 1, further comprising distinguishing three or more types of the identification tag based on the information on the content of the particles having the first feature amount.

16. The method for reading an identification tag according to claim 1, wherein the reading of the identification tag comprises reading a content detection region, which is only a portion of the identification tag, to detect the content of the particles.

17. The method for reading an identification tag according to claim 8, further comprising distinguishing the type of the identification tag based on a ratio of the number of pixels related to the particles having the first feature amount to a total number of pixels related of the image.

18. A method for manufacturing an identification-tagged article, the method comprising:
manufacturing an article having an identification tag by attaching a composition containing particles to the article; and
providing the particles having a first feature amount as a specific feature amount so that a content of the particles is indicative of a type of the identification tag.

19. The method for manufacturing an identification-tagged article according to claim 18, further comprising applying an ink as the composition, with the ink having the particles with the first feature amount dispersed at a predetermined concentration.

20. The method for manufacturing an identification-tagged article according to claim 19, further comprising preparing the ink by mixing the particles having the first feature amount with at least one of a solvent, a dispersant, and a binder resin.
